(19) United States
(12) Patent Application Publication
(10) Pub. No.: US 2017/0004525 A1
(43) Pub. Date: Jan. 5, 2017

(54) ONLINE AD METRICS AND BILLING REPORTING

(71) Applicant: Linkedln Corporation, Mountain View, CA (US)

(72) Inventors: Waitat Peter Poon, Milpitas, CA (US); Alexander Raymond Easton, San Jose, CA (US); Yingxian Wang, Palo Alto, CA (US)

(21) Appl. No.: 14/809,819

(22) Filed: Jul. 27, 2015

Related U.S. Application Data
(60) Provisional application No. 62/186,628, filed on Jun. 30, 2015.

(51) Int. Cl. G06Q 30/02

(52) U.S. Cl. CPC G06Q 30/0249; G06Q 30/0273

(57) ABSTRACT

A machine may be configured to generate metrics or billing reports for online advertising. For example, the machine accesses, in real time, an event cost value associated with an event of consumption of an online ad displayed on behalf of an advertiser associated with an account identifier. The machine accesses, in real time, a remaining budget value associated with the account identifier. The machine determines, in real time, that the event cost value exceeds the remaining budget value. The machine generates, in real time, an adjusted event cost value to correspond to the remaining budget value based on the determining that the event cost value exceeds the remaining budget value. The machine generates, in real time, a real-time billing report including the adjusted event cost value.

### CLAIM OF PRIORITY

This application claims the benefit of priority, under 35 U.S.C. Section 119(e), to U.S. Provisional Patent Application No. 62/186,628 (Attorney Docket No. 3080.D82PRV) by Poon et al., filed on Jun. 30, 2015, which is hereby incorporated herein by reference in its entirety.

### TECHNICAL FIELD

The present application relates generally to the processing of data, and, in various example embodiments, to systems, methods, and computer program products for generating metrics or billing reports for online advertising.

### BACKGROUND

Online advertising debuted as a new advertising medium in the mid-1990s to allow advertisers to promote their products and services on the Internet. Publishers (e.g., website owners) ran online ads on their web sites for the advertisers. The earliest ad serving software utilized by the publishers allowed the display of banner ads in the browsers of the users visiting the publishers' websites. In time, other types of online advertising have appeared, such as sponsored ads, affiliate ads, pay-per-click ads, etc.

As online advertising became more prevalent, certain methods for selling online advertising became more common. The Cost Per Thousand (also “CPM”) model was one of the earliest forms of selling online advertising and was based on an agreed rate for every one thousand impressions served. The Cost Per Click (also “CPC) model was often used and allowed publishers to charge advertisers a higher rate when users clicked on ads.

In addition to selling ad spots on their websites, the publishers are responsible to some degree for managing the advertising on their web sites. Generally, the publisher ensures that the online advertising campaign is set up properly and is receiving the online traffic promised to the advertiser. An online advertising campaign (also “advertising campaign” or “campaign”) may specify one or more types of advertising products (also “ad products”) to be delivered during a campaign delivery period and a collection of common settings that a creative or a group of creatives associated with an ad product should abide by. A creative is a form of advertising material, such as a banner, Hyper Text Markup Language (HTML) form, Flash file, etc. Common creative types include Graphics Interchange Format (GIF), Joint Photographic Experts Group (JPEG), Java, HTML, Flash, or streaming audio/video.

Generally, the publisher also provides reports regarding the advertising campaign to the advertiser. These reports may include campaign performance reports and billing reports. At the most basic level, billing reports provide an accounting of delivered ads (e.g., within certain campaigns) and costs associated with the delivered ads or campaigns, billable to the advertiser.

### BRIEF DESCRIPTION OF THE DRAWINGS

Some embodiments are illustrated by way of example and not limitation in the figures of the accompanying drawings, in which:

FIG. 1 is a network diagram illustrating a client-server system, according to some example embodiments;

FIG. 2 is a block diagram illustrating components of a billing reporting system, according to some example embodiments;

FIG. 3 is a block diagram illustrating components of a real-time analysis module, according to some example embodiments;

FIG. 4 is a diagram illustrating a representation of various types of data utilized or generated by the billing reporting system, according to some example embodiments;

FIG. 5 is a flowchart illustrating a method for generating metrics or billing reports for online advertising, according to some example embodiments;

FIG. 6 is a flowchart illustrating a method for generating metrics or billing reports for online advertising, and representing steps 504, 506, and 508 of the method illustrated in FIG. 5 in more detail, according to some example embodiments;

FIG. 7 is a flowchart illustrating a method for generating metrics or billing reports for online advertising, and representing steps 504, 506, and 508 of the method illustrated in FIG. 5 in more detail, and additional steps of the method illustrated in FIG. 5, according to some example embodiments;

FIG. 8 is a flowchart illustrating a method for generating metrics or billing reports for online advertising, and representing step 510 of the method illustrated in FIG. 5 in more detail, and an additional step of the method illustrated in FIG. 5, according to some example embodiments;

FIG. 9 is a flowchart illustrating a method for generating metrics or billing reports for online advertising, and representing additional steps of the method illustrated in FIG. 5, according to some example embodiments;

FIG. 10 is a flowchart illustrating a method for generating metrics or billing reports for online advertising, and representing additional steps of the method illustrated in FIG. 5, according to some example embodiments;

FIG. 11 is a block diagram illustrating a mobile device, according to some example embodiments; and

FIG. 12 is a block diagram illustrating components of a machine, according to some example embodiments, able to read instructions from a machine-readable medium and perform any one or more of the methodologies discussed herein.

### DETAILED DESCRIPTION

Example methods and systems for generating metrics and billing reports for online advertising are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

Traditionally, an organization that publishes online ads on behalf of an advertiser employs a system for tracking online ad consumption events pertaining to interactions by users with the online ads (e.g., impressions, clicks, conversions, etc.). Such a system may also generate a report that indicates the costs associated with the online ad consumption events (also “ad consumption events,” “consumption events,” or “events”).

However, it is not uncommon for such a traditional reporting system to lack in scalability and, therefore, not be able to support accounts (that represents advertisers) that have large numbers of campaigns and have complex billing and reporting requirements. In some instances, the traditional reporting system experiences timeouts when retrieving the reports for a large number of campaigns for a long report time period.

In some example embodiments, a billing reporting system is designed to scale in order to support a large number of campaigns per account and to accommodate future capacity growth. The billing reporting system generates and transmits ad billing reports in a timely fashion to front-end applications. The billing reporting system provides an offline reporting mechanism for generating reports that consume a large amount of data or reports for date ranges and granularities that are not supported in the traditional reporting systems. The billing reporting system may also generate reports at a campaign group level (e.g., campaigns grouped according to a common attribute, such as a product or service, a geographic location, a goal, etc.). Also, the billing reporting system is designed to control budgets at additional levels.

In some instances, an ad delivery system over-delivers online ads above a particular budget set by the advertiser. The billing reporting system may adjust the billable values in a report, based on account, campaign group, campaign, daily, or total budgets, to not include the costs associated with the over-delivered ads.

According to some example embodiments, the billing reporting system accesses, in real time, an event cost value associated with an event of consumption of an online ad. The online ad may be displayed on behalf of an advertiser. The advertiser may be associated with an account identifier. The billing reporting system also accesses, in real time, a remaining budget value associated with the account identifier. The billing reporting system determines, in real time, that the event cost value associated with the event exceeds the remaining budget value. The billing reporting system generates, in real time, an adjusted event cost value to correspond to the remaining budget value based on the determining that the event cost value exceeds the remaining budget value. The billing reporting system generates, in real time, a real-time billing report including the adjusted event cost value.

The real-time billing report may be made available to the advertiser (e.g., via a user interface) in real time. The billing reporting system may update the real-time billing report displayed to the user, in real time.

In certain example embodiments, the billing reporting system determines that an offline event cost value associated with the event is available and is different from the adjusted event cost value. The billing reporting system generates a report (e.g., a real-time billing report, a final billing report, etc.) including the offline event cost value. The offline event cost value is an event cost value that is associated with the event and that, in some instances, is adjusted based on various factors (e.g., an adjustment rule, a comparison with a particular budget, etc.) In some instances, offline cost values are generated by an offline job (e.g., a Hadoop job) based on historical event data pertaining to one or more events during a particular period of time (e.g., the events that occurred during a day). The billing reporting system may facilitate the tracking of the historical event data in a highly reliable fashion to meet various operational, technical, legal, or business requirements (e.g., redundancy and/or accuracy of data, Sarbanes-Oxley Act (SOX) compliance, Service Level Agreements (SLAs), etc.). Reports generated based on offline cost values are highly accurate and may be used for both real-time billing reporting and final billing reporting. In some instances, the advertiser is charged for the online advertising provided by the publisher based on a final billing report.

In some example embodiments, the real-time billing report may be utilized as a temporary (e.g., ad hoc) report pertaining to a period of time, a particular campaign, a group of campaign, an account, or a suitable combination thereof. The real-time billing report may be displayed, in real time, in a user interface of a device associated with a user. The real-time billing report may serve to inform the user about one or more events of online ad consumption of an online ad associated with an online advertising campaign. The real-time billing report may also include information regarding a spent budget, a remaining budget, and a total budget associated with the advertising campaign. The information presented to the user in the real-time billing report may be updated in real-time, as new events are registered.

A final billing report generated based on offline event cost values may be utilized as a conclusive report pertaining to a period of time, a particular campaign, a group of campaign, an account, or a suitable combination thereof. The final billing report may be used to charge the advertiser for the online advertising delivered on behalf of the advertiser by the publisher to one or more users.

In some example embodiments, the billing reporting system generates a billing report that includes various online ad metrics pertaining to online ad consumption events corresponding to interactions by users with the online ads (e.g., impressions, clicks, conversions, etc.). The billing report may also indicate the costs associated with particular types of events and/or amounts billable to the advertiser based on various types of events, campaigns, or accounts.

In some example embodiments, the billing reporting system may present the report (e.g., the real-time billing report, the final billing report, etc.) in a dashboard. In some instances, the report is displayed in the dashboard in real time. The dashboard, in addition to displaying the contents of the report, may also display various online ad metrics pertaining to the events on which the report is based.

Additionally or alternatively, the billing reporting system may generate, in real time, an online ad over-delivery report based on data pertaining to over-delivery of online ads associated with a particular account identifier. The billing reporting system may present, in real time, the online ad over-delivery report in a dashboard. The dashboard, in addition to displaying the contents of the over-delivery report may also display various online ad metrics pertaining to the events on which the over-delivery report is based. The over-delivery report may be used internally by one or more employees of the publisher to see, in real time, how much money was lost due to over-delivery during a particular period of time.

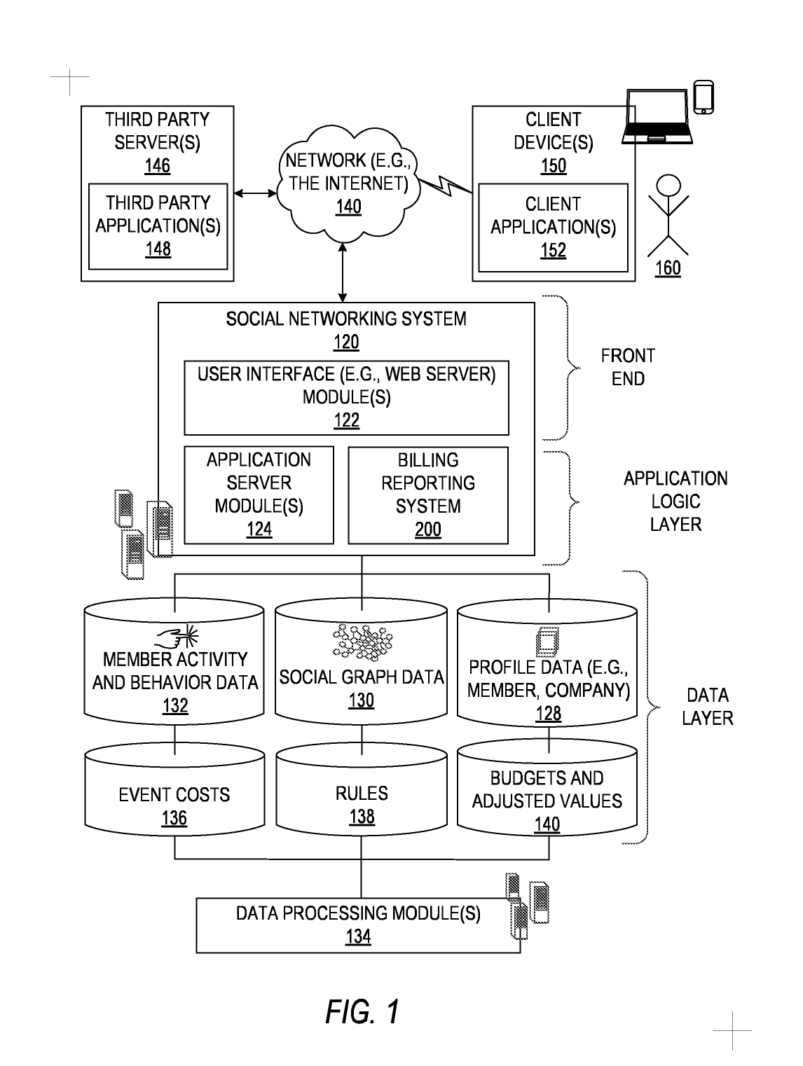

An example method and system for generating metrics or billing reports for online advertising may be implemented in the context of the client-server system illustrated in FIG. 1. As illustrated in FIG. 1, the billing reporting system 200 is part of the social networking system 120. As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client application(s) 152. The client application(s) 152 may provide functionality to present information to the user and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of a social graph. In some example embodiments, a “social graph” is a mechanism used by an online social networking service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. Of course, with various alternative embodiments, any number of other entities may be included in the social graph, and as such, various other databases may be used to store data corresponding to other entities.

Consistent with some embodiments, when a person initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members interact with various applications, content, and user interfaces of the social networking system 120, information relating to the member's activity and behavior may be stored in a database, such as the database 132. An example of such activity and behavior data is the identifier of an online ad consumption event associated with the member (e.g., an online ad viewed by the member), the date and time when the online ad event took place, an identifier of the creative associated with the online ad consumption event, a campaign identifier of an ad campaign associated with the identifier of the creative, etc.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social networking service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130. In some example embodiments, members may receive digital communications (e.g., advertising, news, status updates, etc.) targeted to them based on various factors (e.g., member profile data, social graph data, member activity or behavior data, etc.)

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, social networking system 120 may include the billing reporting system 200, which is described in more detail below.

Further, as shown in FIG. 1, a data processing module 134 may be used with a variety of applications, services, and features of the social networking system 120. The data processing module 134 may periodically access one or more of the databases 128, 130, 132, 136, 138, or 140, process (e.g., execute batch process jobs to analyze or mine) profile data, social graph data, member activity and behavior data, event costs, rules, budget values, or adjusted values, and generate analysis results based on the analysis of the respective data. The data processing module 134 may operate offline. According to some example embodiments, the data processing module 134 operates as part of the social networking system 120. Consistent with other example embodiments, the data processing module 134 operates in a separate system external to the social networking system 120. In some example embodiments, the data processing module 134 may include multiple servers, such as Hadoop servers for processing large data sets. The data processing module 134 may process data in real time, according to a schedule, automatically, or on demand.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

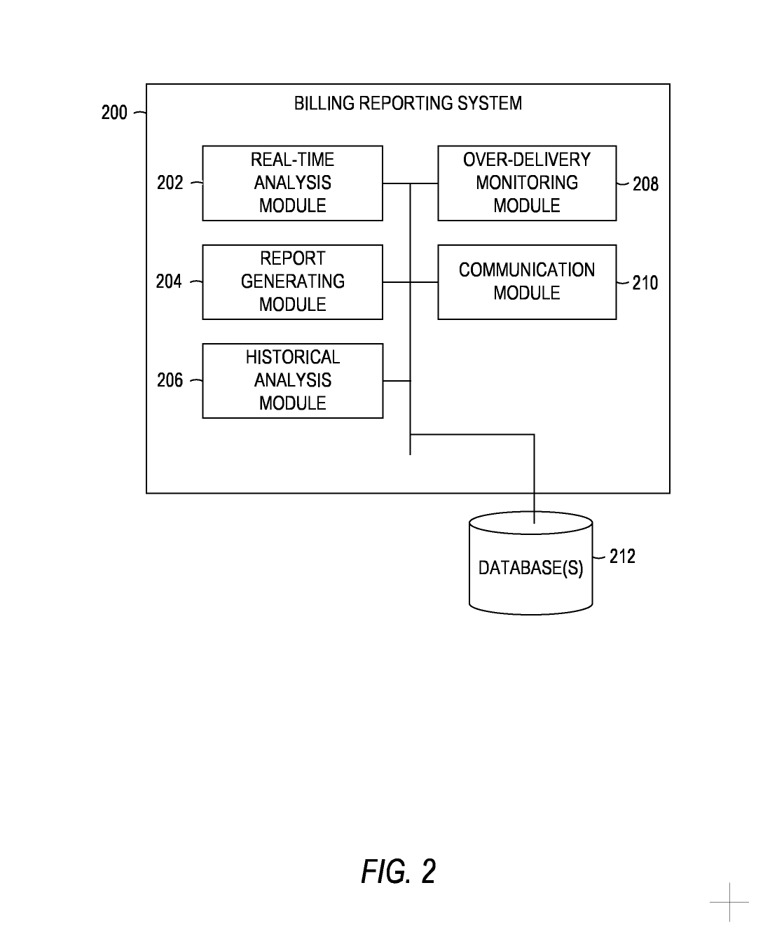

FIG. 2 is a block diagram illustrating components of the billing reporting system 200, according to some example embodiments. As shown in FIG. 2, the billing reporting system 200 includes a real-time analysis module 202, a report generating module 204, a historical analysis module 206, an over-delivery monitoring module 208, and a communication module 210, all configured to communicate with each other (e.g., via a bus, shared memory, or a switch).

According to some example embodiments, the real-time analysis module 202 accesses, in real time, an event cost value associated with an event of consumption, by a user, of an online ad. The event cost value may be stored in database 136. The online ad may be displayed by the social networking system 120 on behalf of an advertiser (e.g., an organization, a company, etc.). The advertiser is associated with an account identifier that may be stored in database 128.

The real-time analysis module 202 also access, in real time, a remaining budget value associated with the account identifier. The remaining budget value may be stored in database 140.

In some example embodiments, the real-time analysis module 202 updates a spent budget value associated with an account based on adding the event cost value to the spent budget value. The real-time analysis module 202 also updates a remaining budget value associated with the account based on subtracting the event cost value from the remaining budget value. For example, an online advertising campaign is associated with a total campaign budget of $100. The event cost value of any event associated with the campaign is $10. The spent budget value associated with the campaign before a first event associated with the campaign is registered is $0. The remaining budget value associated with the campaign is $100. When the first event is registered as occurring, the real-time analysis module 202 updates the spent budget value to be $10 and the remaining budget value to be $90. When the second event is registered as occurring, the real-time analysis module 202 updates the spent budget value to be $20 and the remaining budget value to be $80.

The real-time analysis module 202 determines, in real time, whether the event cost value exceeds the remaining budget value. Based on determining that the event cost value exceeds the remaining budget value, the real-time analysis module 202 generates, in real time, an adjusted event cost value to correspond to the remaining budget value. The real-time analysis module 202 may store the adjusted event cost value in a database 212 (e.g., database 140).

The report generating module 204 generates, in real time, a real-time billing report including the adjusted event cost value. In some instances, when the real-time analysis module 202 determines, in real time, that an offline event cost value associated with the event is available and is different from the adjusted event cost value, the report generating module 204 includes the offline event cost value instead of the adjusted event cost value in the real-time billing report.

The real-time billing report, in some instances, is generated based on one or more criteria, such as an account identifier, a campaign identifier, a reporting time period, etc. In some example embodiments, the report generating module 204 receives an indication of a criterion selected by a user requesting a report from a device associated with the user. The user may select one or more criteria from a user interface of the device associated with the user. The report generating module 204 may generate the report based on applying the user-selected criterion to the event data associated with a plurality of account identifiers.

According to some example embodiments, the billing reporting system 200 generates daily cost values, such as real-time daily cost values determined based on real-time event data associated with the events tracked during a particular date, or offline daily cost values determined based on historical event data associated with the events tracked during a particular date. For instance, a real-time daily cost value for a particular date may be determined based on the aggregation of the adjusted event cost values associated with one or more events that occurred on the particular date using real-time event data pertaining to the one or more events. Further, an offline daily cost value for a particular date may be determined based on the aggregation of the offline event cost values associated with the one or more events that occurred on the particular date using historical event data pertaining to the one or more events. The daily cost values may be utilized to generate daily reports (e.g., real-time billing reports or final billing reports).

For example, a user selects (e.g., clicks on) a particular account identifier (e.g., AccountABC) from a plurality of account identifiers displayed in the user interface of a device of the user. The user also selects a particular date range (e.g., Jun. 1, 2015 to Jun. 7, 2015) using the user interface. Based on these report criteria selected by the user, the report generating module 204 generates a real-time billing report that includes daily cost values associated with the account “AccountABC” for each day from Jun. 1, 2015 to Jun. 7, 2015. If, for example, the offline daily cost value for Jun. 2, 2015 is not available (e.g., due to a temporary system failure), instead of utilizing the offline daily cost value for Jun. 2, 2015, the report generating module 204 uses the adjusted daily event cost value for Jun. 2, 2015. The adjusted daily event cost value for Jun. 2, 2015 is determined based on real-time event data pertaining to the one or more events. Accordingly, the report generating module 204 may generate a report that includes the offline daily event cost values associated with the account “AccountABC” for Jun. 1, 2015, the adjusted event cost value for Jun. 2, 2015, and the offline event cost values for each day from to Jun. 3, 2015 to Jun. 7, 2015.

The historical analysis module 206 determines that an offline event cost value associated with the event is available. The historical analysis module 206 also determines that the offline event cost value is different from the adjusted event cost value. In some example embodiments, the report generating module 204 generates a real-time billing report including the offline event cost value. In some example embodiments, if the historical analysis module 206 determines that an offline event cost value associated with the event is not available or is not different from the adjusted event cost value, the report generating module 204 generates a real-time billing report including the adjusted event cost value associated with the event. In certain example embodiments, a real-time billing report may include the offline event cost value associated with a first event, and the adjusted event cost value associated with a second event.

In some example embodiments, the historical analysis module 206 accesses the event cost value associated with the event. The historical analysis module 206 may also access one or more billing rules associated with the account identifier. The historical analysis module 206 may generate the offline event cost value based on the event cost value and the one or more billing rules.

The over-delivery monitoring module 208 computes an over-delivery amount. The over-delivery amount is an amount by which the event cost value exceeds the remaining budget value. The over-delivery amount represents an over-delivery of the online ad displayed on behalf of the advertiser associated with the account identifier. The report generating module 204 may generate an ad over-delivery report including the over-delivery amount.

The communication module 210 causes the display of a report (e.g., a real-time billing report, a final billing report, etc.) in a user interface associated with a device. In some instances, the device is associated with the advertiser. In certain example embodiments, the communication module 210 is further configured to transmit a communication including a reference to the report to a device associated with the publisher of the online ads (e.g., an employee of a social networking service, such as LinkedIn®.)

To perform one or more of its functionalities, the billing reporting system 200 may communicate with one or more other systems. An integration engine may integrate the billing reporting system 200 with one or more email server(s), web server(s), one or more databases, or other servers, systems, or repositories. A performance engine may determine the performance of one or more modules of the billing reporting system 200. An optimization engine may optimize one or more of the models associated with one or more modules of the billing reporting system 200.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 212 (e.g., database 128, 130, 132, 136, 138, or 140).

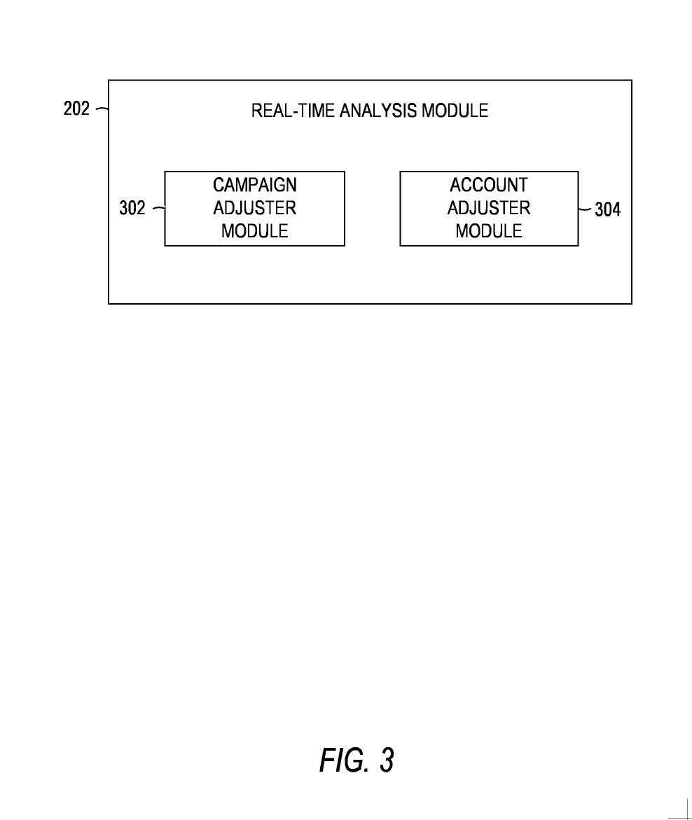

FIG. 3 is a block diagram illustrating components of the real-time analysis module 202, according to some example embodiments. As shown in FIG. 3, the real-time analysis module 202 includes a campaign adjuster module 302 and an account adjuster module 304, both configured to communicate with each other (e.g., via a bus, shared memory, or a switch).

According to some example embodiments, the online ad pertains to an online advertising campaign. The campaign may be a particular campaign of one or more online advertising campaigns associated with the account identifier. The campaign adjuster module 302 accesses a remaining campaign budget value pertaining to a campaign associated with the account identifier.

The account adjuster module 304 accesses a remaining account budget value pertaining to an account associated with the account identifier. The account is associated with one or more campaigns including the campaign.

The campaign adjuster module 302 may also determine that the event cost value does not exceed the remaining campaign budget value pertaining to the campaign. The account adjuster module 304 may also determine that the event cost value exceeds the remaining account budget value pertaining to the account. The generating, in real time, of the adjusted event cost value to correspond to the remaining budget value includes assigning the remaining account budget value to the adjusted event cost value. The adjusted event cost value may be stored in a database 212 (e.g., database 140).

According to certain example embodiments, one or more modules of the billing reporting system 200 access a first remaining budget value pertaining to a first budget-control level (e.g., a campaign level) associated with the account identifier. The one or more modules also access a second remaining budget value pertaining to a second budget-control level (e.g., a campaign group level) associated with the account identifier. The second budget-control level comprising one or more other budget-control levels including the first budget-control level. The one or more modules determine that the event cost value does not exceed the first remaining budget value pertaining to the first budget-control level. The one or more modules determine that the event cost value exceeds the second remaining budget value pertaining to the second budget-control level. The generating, in real time, (e.g., by the one or more modules) of the adjusted event cost value to correspond to the remaining budget value includes assigning the second remaining budget value to the adjusted event cost value.

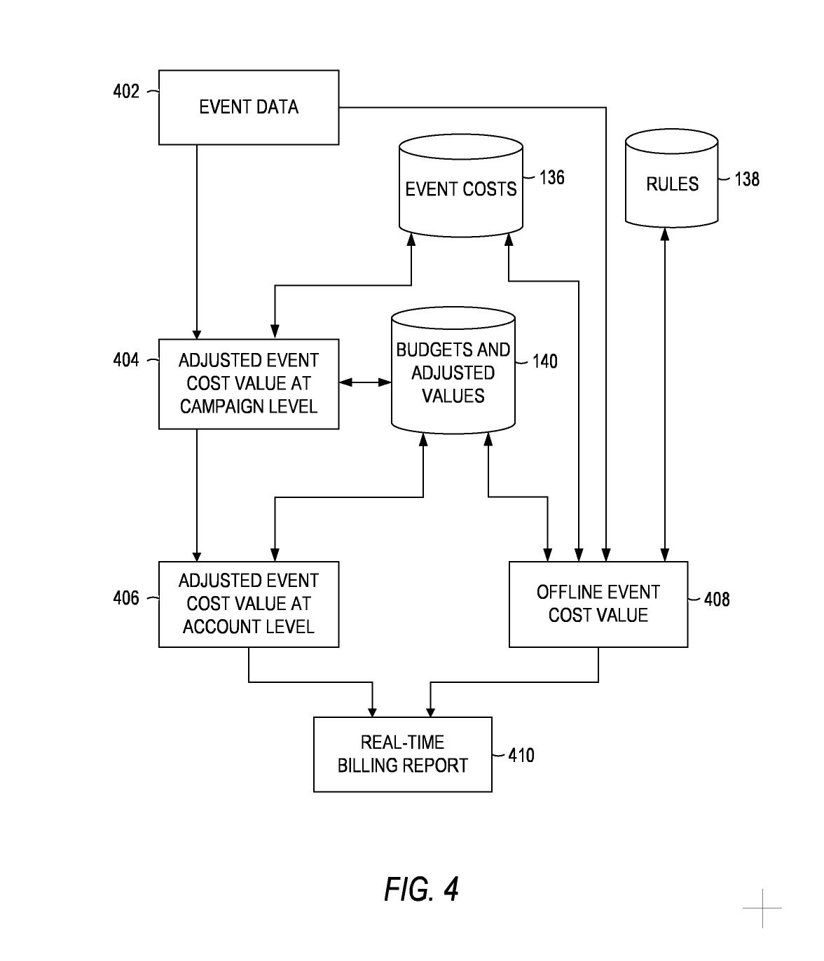

FIG. 4 is a diagram illustrating a representation of various types of data utilized or generated by the billing reporting system, according to some example embodiments. As shown in FIG. 4, the billing reporting system 200 accesses, in real time, event data 402 that pertains to an event of online ad consumption by a user. The online ad is associated with an account identifier representing an advertiser.

In some example embodiments, the event data 402 is received from an event tracking system that monitors online ad consumption events by one or more users (e.g., members of the social networking service). The event data 402 may include metrics describing aspects of user interactions with online ads (e.g., impressions, clicks, clicksOther, conversions, costs, currency, likes, comments, shares, follows, viewContent, viewUpdate, viewCompany, etc.)

In some example embodiments, the billing reporting system 200 may identify, in real time, a type of event of a particular event based on the event data 402, and may access an event cost value associated with the particular type of event and/or the account identifier from the event costs database 136. The billing reporting system 200 may also identify, in real time, a campaign identifier of a campaign that includes the online ad associated with the event based on the event data 402.

The billing reporting system 200 may also access, in real time, a remaining campaign budget value associated with the campaign identifier from the budgets and adjusted values database 140. The remaining campaign budget value represents a budget remaining in a campaign associated with the event. The remaining campaign budget value may be determined based on subtracting the spent campaign budget value associated with one or more other events pertaining to the campaign from the total campaign budget value associated with the campaign.

The billing reporting system 200 may determine, in real time, that the event cost value exceeds the remaining campaign budget value. The billing reporting system 200 may generate, in real-time, an adjusted event cost value 404, at the campaign level, to correspond to the remaining campaign budget value. The billing reporting system 200 may store the adjusted event cost value 404 determined at the campaign level in the budgets and adjusted values database 140.

The billing reporting system 200 may also access, in real time, a remaining account budget value associated with the account identifier from the budgets and adjusted values database 140. The remaining account budget value represents a budget remaining in an account associated with the campaign. The remaining account budget value may be determined based on subtracting the spent account budget value associated with one or more campaigns including the campaign from the total account budget value associated with the account.

The billing reporting system 200 may determine, in real time, that the adjusted event cost value 404 generated at the campaign level exceeds the remaining account budget value. The billing reporting system 200 may update, in real-time, the adjusted event cost value 404, at the account level, to correspond to the remaining account budget value. The billing reporting system 200 may store the adjusted event cost value 406 determined at the account level in the budgets and adjusted values database 140.

The billing reporting system 200 may reiterate this process for other event data 402 describing other ad consumption events associated with one or more online ads associated with the campaign identifier and/or account identifier. Accordingly, the adjusted event cost value 404 and/or the adjusted event cost value 406 is generated (e.g., adjusted, updated, etc.), in real time, based on each new event of consumption of the online ads associated with the campaign identifier and/or account identifier.

In certain example embodiments, the billing reporting system 200 uses an offline job to generate reporting data based on historical event data associated with a particular time range (e.g., daily, weekly, monthly, etc.). The historical event data may include various information describing online ad consumption events (e.g., number of clicks, number of impressions, etc.). The historical event data is highly reliable and, in some instances, is more reliable than the event data utilized in the real time analysis described above. The historical event data is also compliant with a high Service-Level Agreement (SLA) level (e.g., a guarantee of data accuracy, redundancy mechanisms to protect against loss of data, etc.).

The billing reporting system 200 accesses event data 402 (e.g., historical event data) pertaining to the event of consumption of the online ad. The online ad is associated with a creative and pertains to an online advertising campaign. The event data 402 may include a creative identifier for the online ad, a campaign identifier that indicates the campaign that includes the creative associated with the online ad, an account identifier that represents the account that includes the campaign, the cost associated with the event, etc.

The billing reporting system 200 may determine, based on the event data 402, a type of event and an account identifier associated with the online ad consumption event, as well as a campaign identifier associated with the campaign that includes the online ad associated with the event. In some example embodiments, the billing reporting system 200 accesses the event cost associated with the particular event from the event costs database 136. In other instances, the event cost value is accessed from the event data 402. The billing reporting system 200 also access one or more rules associated with the account identifier from the rules database 138.

The one or more rules specify how to bill the account for the event. The one or more rules associated with a specific account may be generated based on the contract between the advertiser represented by the account and the publisher of the online advertising. For example, a rule may specify certain budgets for the account and for the campaigns included in the account.

In some example embodiments, a rule for adjustment of billable values may specify that the billable values associated with particular campaigns should be adjusted in some proportion if an over-delivery of ads occurs above a budget amount (e.g., a campaign budget value or an account budget value). The billing reporting system 200 may look to the rules database 138 as the final authority and may correct the offline event cost values according to one or more billing rules.

The billing reporting system 200 generates one or more real-time billing reports 410 to provide information pertaining to the online ad consumption events of the online advertising provided by the publisher on behalf of the advertiser. In some example embodiments, the billing reporting system 200 generates, in real time, a real-time billing report 410 including adjusted event cost values 406 pertaining to one or more events, offline event cost values 408 pertaining to one or more events, or both. For example, the billing reporting system 200 determines, in real time, that the offline event cost value 408 for a first event is not available (e.g., has not yet been determined by the offline job) and that the offline event cost value 408 for a second event is available. The billing reporting system 200 then generates, in real time, the real-time billing report 410 to include the adjusted event cost value 406 for the first and the offline event cost value 408 for the second event.

In some example embodiments, the billing reporting system 200 computes an over-delivery amount representing an over-delivery of the online ad. The billing reporting system 200 may generate an ad over-delivery report including the over-delivery amount.

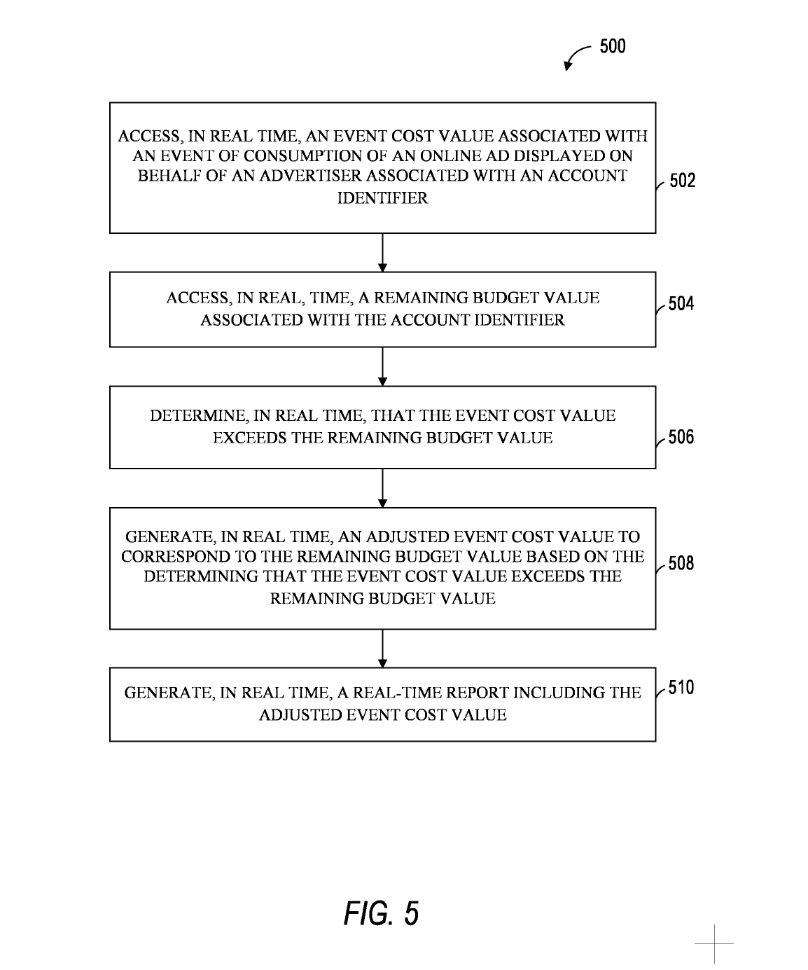

FIGS. 5-10 are flowcharts illustrating a method for generating metrics or billing reports for online advertising, according to some example embodiments. Operations in the method 500 illustrated in FIG. 5 may be performed using modules described above with respect to FIGS. 2 and 3. As shown in FIG. 5, method 500 may include one or more of method operations 502, 504, 506, 508, and 510, according to some example embodiments.

At method operation 502, the real-time analysis module 202 accesses, in real time, an event cost value associated with an event of consumption, by a user, of an online ad. The online ad is displayed (e.g., by a system of a publisher, such as LinkedIn®) on behalf of an advertiser associated with an account identifier. The online ad may comprise a creative, and may be associated with a creative identifier. The creative may be part of (e.g., included in) an online advertising campaign for one or more products or services provided by the advertiser.

At method operation 504, the real-time analysis module 202 accesses, in real time, a remaining budget value associated with the account identifier. The remaining budget value represents a difference between a total budget value associated with the account identifier, and a spent budget value associated with the account identifier. In some example embodiments, a sum of the remaining budget value and a spent budget value associated with the account identifier corresponds to an account budget value associated with the account identifier. In certain example embodiments, a sum of the remaining budget value and a spent budget value associated with the account identifier corresponds to a campaign budget value associated with the account identifier.

At method operation 506, the real-time analysis module 202 determines, in real time, that the event cost value exceeds the remaining budget value. The real-time analysis module 202 may determine that the event cost value exceeds the remaining budget value based on comparing the event cost value and the remaining budget value. The difference between the event cost value and the remaining budget value may correspond to an over-delivery amount representing an over-delivery of the online ad.

At method operation 508, the real-time analysis module 202 generates, in real time, an adjusted event cost value to correspond to the remaining budget value based on the determining that the event cost value exceeds the remaining budget value. The generating, in real time, of the adjusted event cost value to correspond to the remaining budget value may include determining that the event cost value exceeds the remaining budget value, and assigning the remaining budget value to the adjusted event cost value.

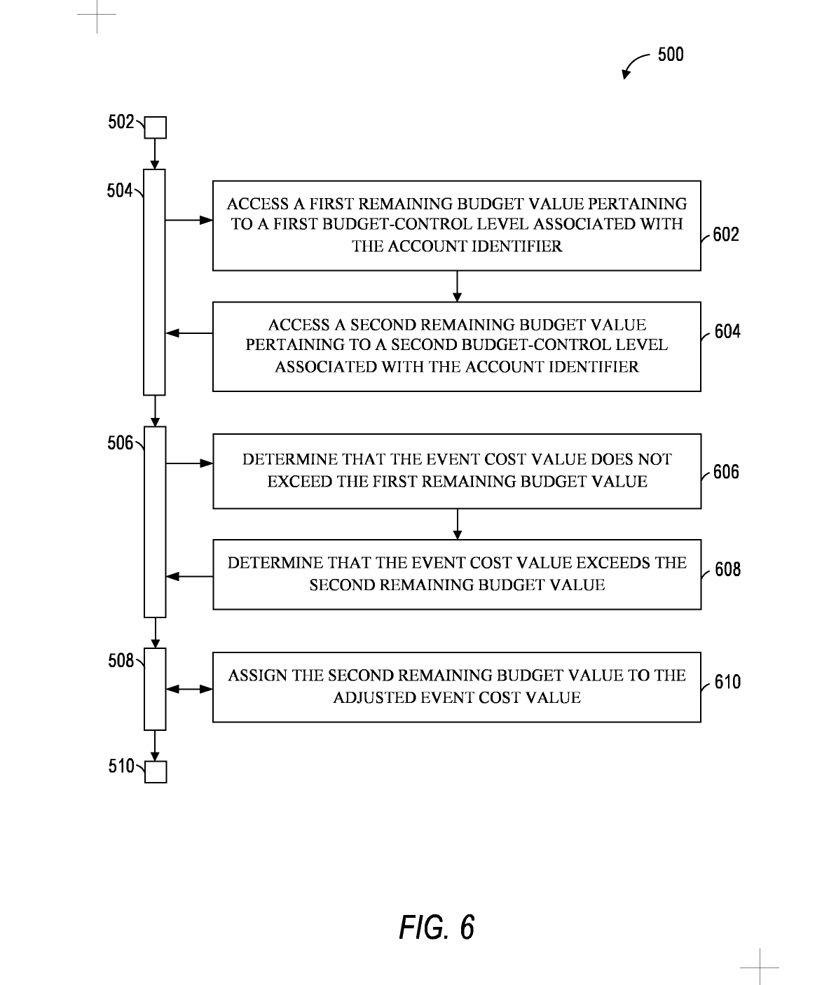

At method operation 510, the report generating module 204 generates, in real time, a real-time billing report including the adjusted event cost value. Further details with respect to the method operations of the method 500 are described below with respect to FIGS. 6-10.

As shown in FIG. 6, the method 500 may include one or more of operations 602, 604, 606, 608, and 610, according to some example embodiments. Method operation 602 may be performed as part (e.g., a precursor task, a subroutine, or a portion) of method operation 504, in which the real-time analysis module 202 accesses, in real time, a remaining budget value associated with the account identifier.

At method operation 602, the real-time analysis module 202 accesses, in real time, a first remaining budget value pertaining to a first budget-control level associated with the account identifier. In some example embodiments, the first remaining budget value may be a remaining campaign group budget value corresponding to a remaining budget associated with a group of campaigns after accounting for one or more events of online ad consumption of an ad pertaining to the group of campaigns (e.g., an ad included in one of the campaigns comprised in the group of campaigns). The first budget-control level may be a campaign group level in a hierarchy of budget control levels (e.g., the campaign budget-control level, the campaign group budget-control level, the account budget-control level, etc.) associated with the account. The group of campaigns may comprise a plurality of campaigns grouped based on a common aspect of the campaigns. For example, the plurality of campaigns covers online advertising pertaining to a particular product. According to another example, the plurality of campaigns covers online advertising targeting a particular geographic zone (e.g., North America). According to yet another example, the plurality of campaigns covers online advertising that have a particular goal (e.g., increasing the number of followers).

Method operation 604 may be performed after method operation 602. At method operation 604, the real-time analysis module 202 accesses, in real time, a second remaining budget value pertaining to a second budget-control level associated with the account identifier. The second budget-control level may comprise one or more other budget-control levels including the first budget-control level. In some example embodiments, the second remaining budget may be a remaining account budget value corresponding to a remaining budget associated with the account representing the advertiser. The second budget-control level may be the account budget-control level, and may comprise at least the campaign group budget-control level.

Method operation 606 may be performed as part (e.g., a precursor task, a subroutine, or a portion) of method operation 506, in which the real-time analysis module 202 determines, in real time, that the event cost value exceeds the remaining budget value. At method operation 606, the real-time analysis module 202 determines that the event cost value does not exceed the first remaining budget value pertaining to the first budget-control level.

Method operation 608 may be performed after method operation 606. At method operation 608, the real-time analysis module 202 determines that the event cost value exceeds the second remaining budget value pertaining to the second budget-control level.

Method operation 610 may be performed as part (e.g., a precursor task, a subroutine, or a portion) of method operation 508, in which the real-time analysis module 202 generates, in real time, an adjusted event cost value to correspond to the remaining budget value. At method operation 610, the real-time analysis module 202 assigns the second remaining budget value to the adjusted event cost value.

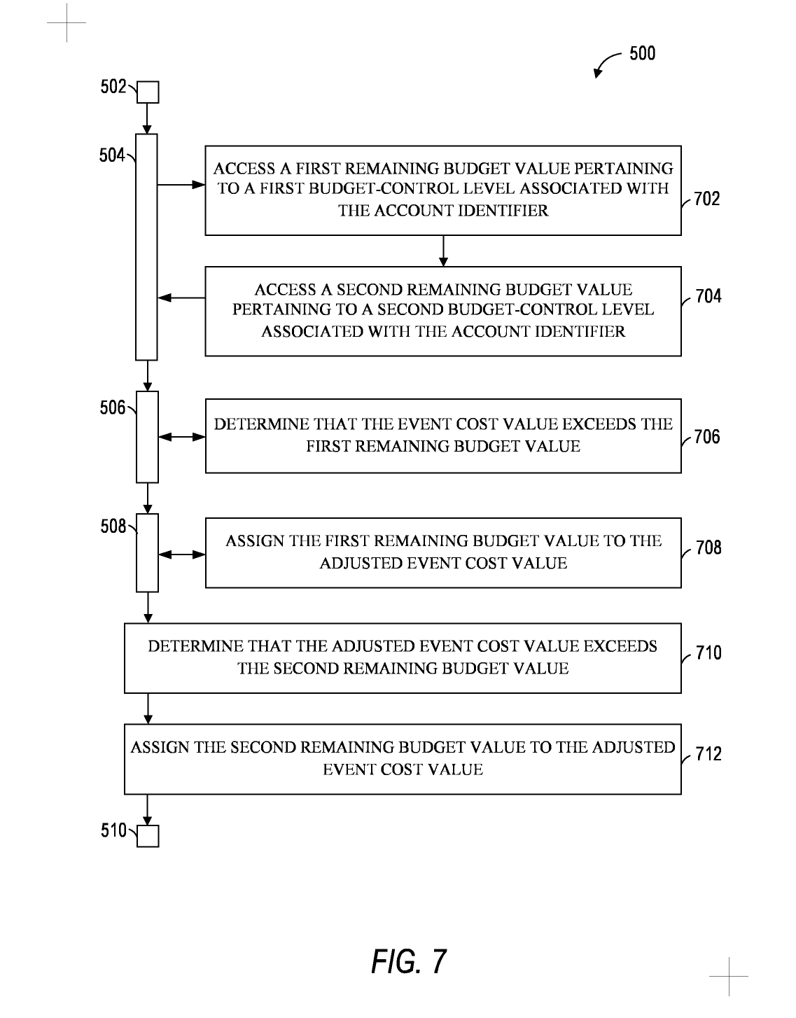

As shown in FIG. 7, the method 500 may include method operations 702, 704, 706, 708, 710, and 712, according to some example embodiments. Method operation 702 may be performed as part (e.g., a precursor task, a subroutine, or a portion) of method operation 504, in which the real-time analysis module 202 accesses, in real time, a remaining budget value associated with the account identifier.

At method operation 702, the real-time analysis module 202 accesses a first (e.g., a campaign) remaining budget value pertaining to a first budget-control level (e.g., a campaign budget-control level) associated with the account identifier.

Method operation 704 may be performed after method operation 702. At method operation 704, the real-time analysis module 202 accesses a second (e.g., an account) remaining budget value pertaining to a second budget-control level (e.g., an account budget-control level) associated with the account identifier. The second budget-control level comprises one or more other budget-control levels including the first budget-control level (e.g., the campaign budget-control level).

Method operation 706 may be performed as part (e.g., a precursor task, a subroutine, or a portion) of method operation 506, in which the real-time analysis module 202 determines, in real time, that the event cost value exceeds the remaining budget value. At method operation 706, the real-time analysis module 202 determines, in real time, that the event cost value exceeds the first remaining budget value pertaining to the first budget-control level.

Method operation 708 may be performed as part (e.g., a precursor task, a subroutine, or a portion) of method operation 508, in which the real-time analysis module 202 the real-time analysis module 202 generates, in real time, an adjusted event cost value to correspond to the remaining budget value. At method operation 708, the real-time analysis module 202 assigns, in real time, the first remaining budget value to the adjusted event cost value.

Method operation 710 may be performed after method operation 508. At method operation 710, the real-time analysis module 202 determines, in real time, that the adjusted event cost value exceeds the second remaining budget value.

Method operation 712 may be performed after method operation 710. At method operation 712, the real-time analysis module 202 assigns, in real time, the second remaining budget value to the adjusted event cost value.

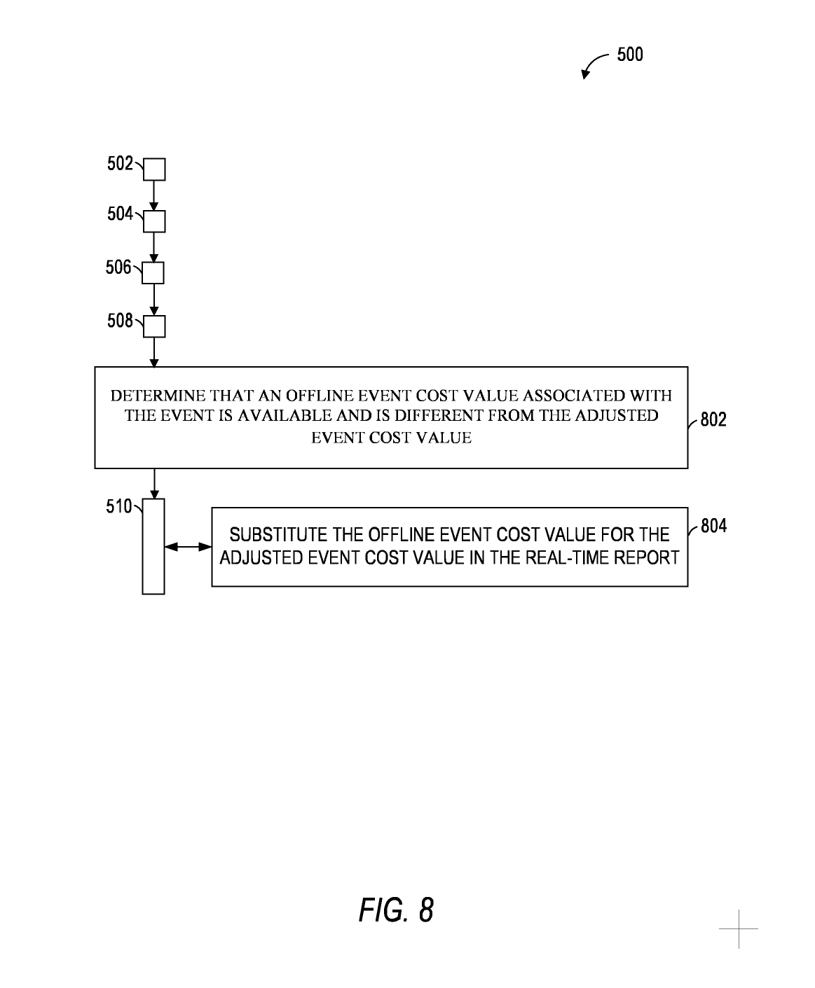

As shown in FIG. 8, the method 800 may include method operations 802 and 804, according to some example embodiments. Method operation 802 may be performed after method operation 508, in which the real-time analysis module 202 generates, in real time, an adjusted event cost value to correspond to the remaining budget value. At method operation 802, the real-time analysis module 202 determines that an offline event cost value associated with the event is available and is different from the adjusted event cost value.

Method operation 804 may be performed as part (e.g., a precursor task, a subroutine, or a portion) of method operation 510, in which the report generating module 204 generates, in real time, a real-time billing report including the adjusted event cost value. At method operation 804, the report generating module 204 substitutes the offline event cost value for the adjusted event cost value in the real-time billing report based on determining that the offline event cost value associated with the event is different from the adjusted event cost value. For example, instead of including the adjusted event cost value in the real-time report associated with the event, the report generating module 204 includes the offline event cost value associated with the event. An example reason for utilizing the offline event cost value, if available, in the real-time billing report is the possibility that the offline event cost value is more accurate than the adjusted event cost value.

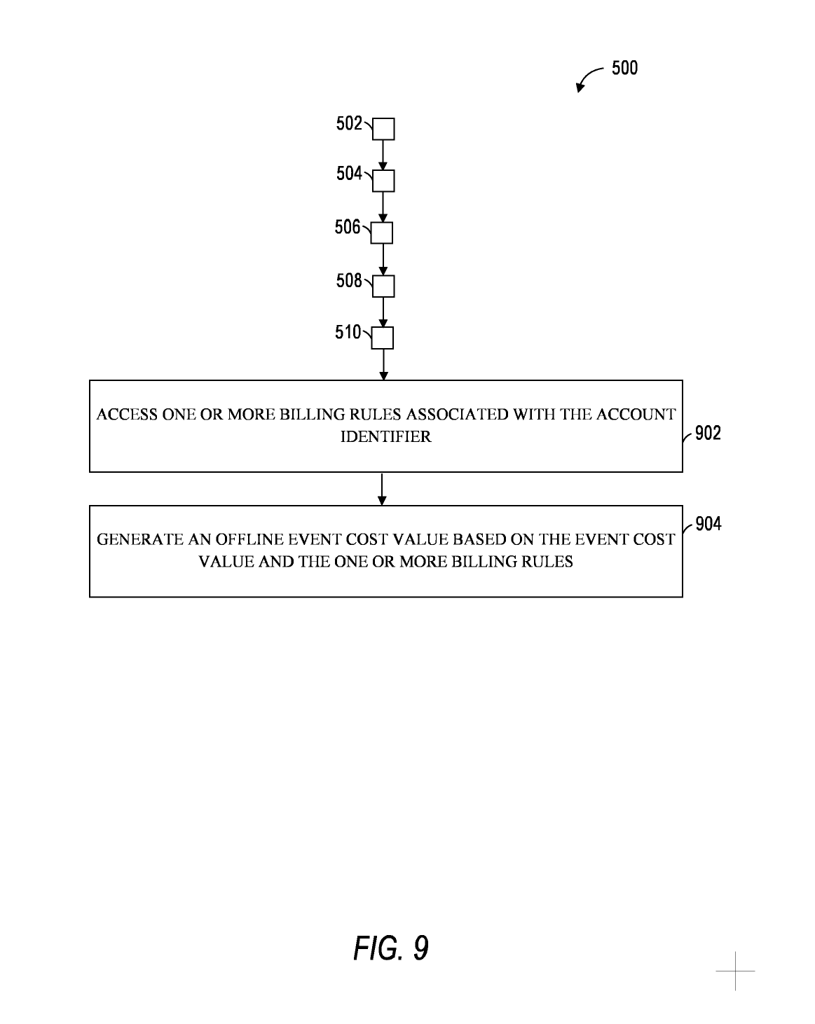

As shown in FIG. 9, the method 500 may include one or more of operations 902 and 904, according to some example embodiments. Method operation 902 is performed after method operation 510, in which the report generating module 204 generates, in real time, a real-time billing report including the adjusted event cost value.

At method operation 902, the real-time analysis module 202 accesses one or more billing rules associated with the account identifier.

At method operation 904, the real-time analysis module 202 generates an offline event cost value based on the event cost value and the one or more billing rules.

In some example embodiments, the event is a first event, the adjusted event cost value is a first adjusted event cost value associated with the first event, and the offline event cost value is a first offline event cost value associated with the first event. The real-time analysis module 202 determines, in real time, that a second adjusted event cost value associated with a second event is not available. The real-time analysis module 202 accesses a second offline event cost value associated with the second event. The report generating module 204 further includes the second offline event cost value in the real-time billing report.

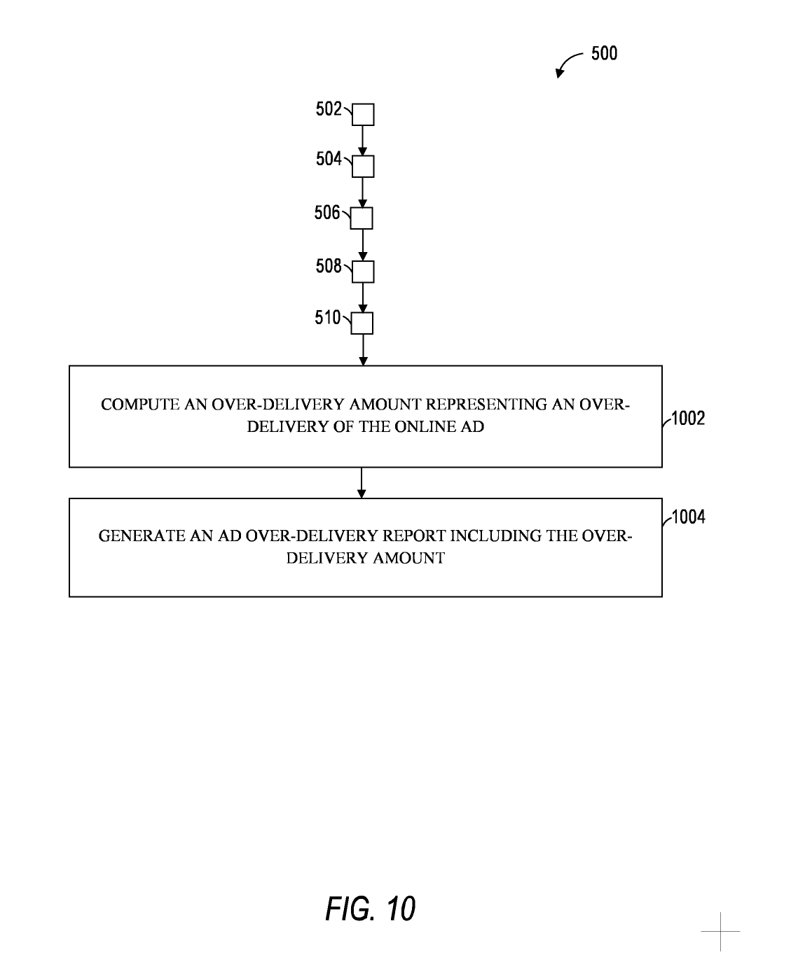

As shown in FIG. 10, the method 500 may include one or more of operations 1002 and 1004, according to some example embodiments. Method operation 1002 is performed after method operation 510, in which the report generating module 204 generates, in real time, a real-time billing report including the adjusted event cost value.

At method operation 1002, the real-time analysis module 202 computes an over-delivery amount representing an over-delivery of the online ad. The computing of the over-delivery amount may be based on event cost values associated with one or more events including the event, and one or more remaining budget values associated with the account identifier.

At method operation 1004, report generating module 204 generates an ad over-delivery report including the over-delivery amount. In some example embodiments, the over-delivery amount is included in the real-time billing report.

### Example Mobile Device

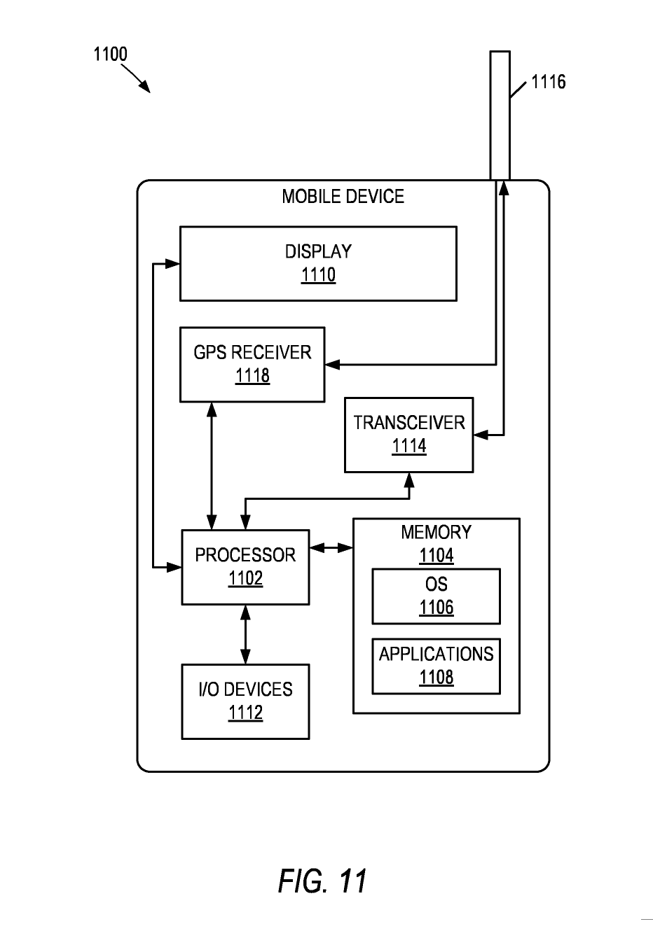

FIG. 11 is a block diagram illustrating a mobile device 1100, according to an example embodiment. The mobile device 1100 may include a processor 1102. The processor 1102 may be any of a variety of different types of commercially available processors 1102 suitable for mobile devices 1100 (for example, an XScale architecture microprocessor, a microprocessor without interlocked pipeline stages (MIPS) architecture processor, or another type of processor 1102). A memory 1104, such as a random access memory (RAM), a flash memory, or other type of memory, is typically accessible to the processor 1102. The memory 1104 may be adapted to store an operating system (OS) 1106, as well as application programs 1108, such as a mobile location enabled application that may provide LBSs to a user. The processor 1102 may be coupled, either directly or via appropriate intermediary hardware, to a display 1110 and to one or more input/output (I/O) devices 1112, such as a keypad, a touch panel sensor, a microphone, and the like. Similarly, in some embodiments, the processor 1102 may be coupled to a transceiver 1114 that interfaces with an antenna 1116. The transceiver 1114 may be configured to both transmit and receive cellular network signals, wireless data signals, or other types of signals via the antenna 1116, depending on the nature of the mobile device 1100. Further, in some configurations, a GPS receiver 1118 may also make use of the antenna 1116 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

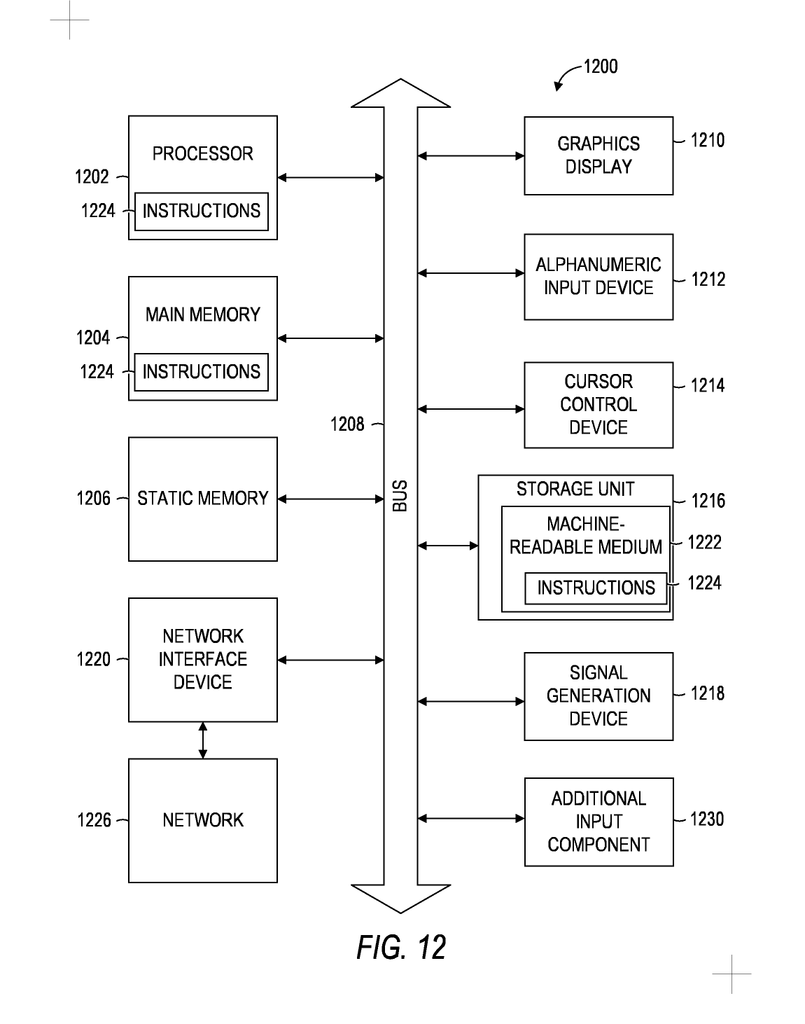

FIG. 12 is a block diagram illustrating components of a machine 1200, according to some example embodiments, able to read instructions 1224 from a machine-readable medium 1222 (e.g., a non-transitory machine-readable medium, a machine-readable storage medium, a computer-readable storage medium, or any suitable combination thereof) and perform any one or more of the methodologies discussed herein, in whole or in part. Specifically, FIG. 12 shows the machine 1200 in the example form of a computer system (e.g., a computer) within which the instructions 1224 (e.g., software, a program, an application, an applet, an app, or other executable code) for causing the machine 1200 to perform any one or more of the methodologies discussed herein may be executed, in whole or in part.

In alternative embodiments, the machine 1200 operates as a standalone device or may be connected (e.g., networked) to other machines. In a networked deployment, the machine 1200 may operate in the capacity of a server machine or a client machine in a server-client network environment, or as a peer machine in a distributed (e.g., peer-to-peer) network environment. The machine 1200 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1224, sequentially or otherwise, that specify actions to be taken by that machine. Further, while only a single machine is illustrated, the term “machine” shall also be taken to include any collection of machines that individually or jointly execute the instructions 1224 to perform all or part of any one or more of the methodologies discussed herein.

The machine 1200 includes a processor 1202 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1204, and a static memory 1206, which are configured to communicate with each other via a bus 1208. The processor 1202 may contain microcircuits that are configurable, temporarily or permanently, by some or all of the instructions 1224 such that the processor 1202 is configurable to perform any one or more of the methodologies described herein, in whole or in part. For example, a set of one or more microcircuits of the processor 1202 may be configurable to execute one or more modules (e.g., software modules) described herein.

The machine 1200 may further include a graphics display 1210 (e.g., a plasma display panel (PDP), a light emitting diode (LED) display, a liquid crystal display (LCD), a projector, a cathode ray tube (CRT), or any other display capable of displaying graphics or video). The machine 1200 may also include an alphanumeric input device 1212 (e.g., a keyboard or keypad), a cursor control device 1214 (e.g., a mouse, a touchpad, a trackball, a joystick, a motion sensor, an eye tracking device, or other pointing instrument), a storage unit 1216, an audio generation device 1218 (e.g., a sound card, an amplifier, a speaker, a headphone jack, or any suitable combination thereof), and a network interface device 1220.

The storage unit 1216 includes the machine-readable medium 1222 (e.g., a tangible and non-transitory machine-readable storage medium) on which are stored the instructions 1224 embodying any one or more of the methodologies or functions described herein. The instructions 1224 may also reside, completely or at least partially, within the main memory 1204, within the processor 1202 (e.g., within the processor's cache memory), or both, before or during execution thereof by the machine 1200. Accordingly, the main memory 1204 and the processor 1202 may be considered machine-readable media (e.g., tangible and non-transitory machine-readable media). The instructions 1224 may be transmitted or received over the network 1226 via the network interface device 1220. For example, the network interface device 1220 may communicate the instructions 1224 using any one or more transfer protocols (e.g., hypertext transfer protocol (HTTP)).

In some example embodiments, the machine 1200 may be a portable computing device, such as a smart phone or tablet computer, and have one or more additional input components 1230 (e.g., sensors or gauges). Examples of such input components 1230 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1222 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1224 for execution by the machine 1200, such that the instructions 1224, when executed by one or more processors of the machine 1200 (e.g., processor 1202), cause the machine 1200 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing, in real time, an event cost value associated with an event of consumption of an online ad displayed on behalf of an advertiser associated with an account identifier;
accessing, in real time, a remaining budget value associated with the account identifier;
determining, in real time, that the event cost value exceeds the remaining budget value;
generating, in real time, an adjusted event cost value to correspond to the remaining budget value based on the determining that the event cost value exceeds the remaining budget value; and
generating, in real time, a real-time billing report including the adjusted event cost value.

2. The method of claim 1, wherein the accessing of the remaining budget value includes:
accessing a first remaining budget value pertaining to a first budget-control level associated with the account identifier, and
accessing a second remaining budget value pertaining to a second budget-control level associated with the account identifier, the second budget-control level comprising one or more other budget-control levels including the first budget-control level;
wherein the determining that the event cost value exceeds the remaining budget value includes:
determining that the event cost value does not exceed the first remaining budget value pertaining to the first budget-control level, and
determining that the event cost value exceeds the second remaining budget value pertaining to the second budget-control level; and
wherein the generating, in real time, of the adjusted event cost value to correspond to the remaining budget value includes assigning the second remaining budget value to the adjusted event cost value.

3. The method of claim 1, wherein the accessing of the remaining budget value includes:
accessing a first remaining budget value pertaining to a first budget-control level associated with the account identifier, and
accessing a second remaining budget value pertaining to a second budget-control level associated with the account identifier, the second budget-control level comprising one or more other budget-control levels including the first budget-control level;
wherein the determining that the event cost value exceeds the remaining budget value includes determining that the event cost value exceeds the first remaining budget value pertaining to the first budget-control level; and
wherein the generating, in real time, of the adjusted event cost value to correspond to the remaining budget value includes assigning the first remaining budget value to the adjusted event cost value; the method further comprising:
determining that the adjusted event cost value exceeds the second remaining budget value pertaining to the second budget-control level; and
assigning the second remaining budget value to the adjusted event cost value.

4. The method of claim 1, wherein the accessing of the remaining budget value includes:
accessing a remaining campaign budget value pertaining to a campaign associated with the account identifier, and
accessing a remaining account budget value pertaining to an account associated with the account identifier, the account being associated with one or more campaigns including the campaign;
wherein the determining that the event cost value exceeds the remaining budget value includes:
determining that the event cost value does not exceed the remaining campaign budget value pertaining to the campaign, and
determining that the event cost value exceeds the remaining account budget value pertaining to the account; and
wherein the generating, in real time, of the adjusted event cost value to correspond to the remaining budget value includes assigning the remaining account budget value to the adjusted event cost value.

5. The method of claim 1, further comprising:
determining, in real time, that an offline event cost value associated with the event is available and is different from the adjusted event cost value, wherein
the generating, in real time, of the real-time billing report includes substituting the offline event cost value for the adjusted event cost value in the real-time billing report.

6. The method of claim 1, further comprising:
accessing one or more billing rules associated with the account identifier; and
generating an offline event cost value based on the event cost value and the one or more billing rules.

7. The method of claim 6, wherein the event is a first event, the adjusted event cost value is a first adjusted event cost value associated with the first event, and the offline event cost value is a first offline event cost value associated with the first event; the method further comprising:
determining, in real time, that a second adjusted event cost value associated with a second event is not available; and
accessing a second offline event cost value associated with the second event,
wherein the real-time billing report further includes the second offline event cost value.

8. The method of claim 1, wherein a sum of the remaining budget value and a spent budget value associated with the account identifier corresponds to an account budget value associated with the account identifier.

9. The method of claim 1, wherein a sum of the remaining budget value and a spent budget value associated with the account identifier corresponds to a campaign budget value associated with the account identifier.

10. The method of claim 1, wherein the generating, in real time, of the adjusted event cost value to correspond to the remaining budget value includes:
determining that the event cost value exceeds the remaining budget value; and
assigning the remaining budget value to the adjusted event cost value.

11. The method of claim 1, further comprising:
computing an over-delivery amount representing an over-delivery of the online ad; and
generating an ad over-delivery report including the over-delivery amount.

12. The method of claim 11, wherein the computing of the over-delivery amount is based on one or more events including the event.

13. A system comprising:
a machine-readable medium for storing instructions that, when executed by one or more hardware processors of a machine, cause the machine to perform operations comprising:
accessing, in real time, an event cost value associated with an event of consumption of an online ad displayed on behalf of an advertiser associated with an account identifier;
accessing, in real time, a remaining budget value associated with the account identifier;
determining, in real time, that the event cost value exceeds the remaining budget value;
generating, in real time, an adjusted event cost value to correspond to the remaining budget value based on the determining that the event cost value exceeds the remaining budget value; and
generating, in real time, a real-time billing report including the adjusted event cost value.

14. The system of claim 13, wherein the accessing of the remaining budget value includes:
accessing a first remaining budget value pertaining to a first budget-control level associated with the account identifier, and
accessing a second remaining budget value pertaining to a second budget-control level associated with the account identifier, the second budget-control level comprising one or more other budget-control levels including the first budget-control level;
wherein the determining that the event cost value exceeds the remaining budget value includes:
determining that the event cost value does not exceed the first remaining budget value pertaining to the first budget-control level, and
determining that the event cost value exceeds the second remaining budget value pertaining to the second budget-control level; and
wherein the generating, in real time, of the adjusted event cost value to correspond to the remaining budget value includes assigning the second remaining budget value to the adjusted event cost value.

15. The system of claim 13, wherein the accessing of the remaining budget value includes:
accessing a first remaining budget value pertaining to a first budget-control level associated with the account identifier, and
accessing a second remaining budget value pertaining to a second budget-control level associated with the account identifier, the second budget-control level comprising one or more other budget-control levels including the first budget-control level;
wherein the determining that the event cost value exceeds the remaining budget value includes determining that the event cost value exceeds the first remaining budget value pertaining to the first budget-control level; and
wherein the generating, in real time, of the adjusted event cost value to correspond to the remaining budget value includes assigning the first remaining budget value to the adjusted event cost value, and
wherein the operations further comprise:
determining that the adjusted event cost value exceeds the second remaining budget value pertaining to the second budget-control level; and
assigning the second remaining budget value to the adjusted event cost value.

16. The system of claim 13, wherein the accessing of the remaining budget value includes:
accessing a remaining campaign budget value pertaining to a campaign associated with the account identifier, and
accessing a remaining account budget value pertaining to an account associated with the account identifier, the account being associated with one or more campaigns including the campaign;
wherein the determining that the event cost value exceeds the remaining budget value includes:
determining that the event cost value does not exceed the remaining campaign budget value pertaining to the campaign, and
determining that the event cost value exceeds the remaining account budget value pertaining to the account; and
wherein the generating, in real time, of the adjusted event cost value to correspond to the remaining budget value includes assigning the remaining account budget value to the adjusted event cost value.

17. The system of claim 13, wherein the operations further comprise:
determining, in real time, that an offline event cost value associated with the event is available and is different from the adjusted event cost value, wherein
the generating, in real time, of the real-time billing report includes substituting the offline event cost value for the adjusted event cost value in the real-time billing report.

18. The system of claim 13, wherein the operations further comprise:
accessing one or more billing rules associated with the account identifier; and
generating an offline event cost value based on the event cost value and the one or more billing rules.

19. The system of claim 18, wherein the event is a first event, the adjusted event cost value is a first adjusted event cost value associated with the first event, and the offline event cost value is a first offline event cost value associated with the first event, and wherein the operations further comprise:
determining, in real time, that a second adjusted event cost value associated with a second event is not available; and
accessing a second offline event cost value associated with the second event,
wherein the real-time billing report further includes the second offline event cost value.

20. A non-transitory machine-readable storage medium comprising instructions that, when executed by one or more processors of a machine, cause the machine to perform operations comprising:
accessing, in real time, an event cost value associated with an event of consumption of an online ad displayed on behalf of an advertiser associated with an account identifier;
accessing, in real time, a remaining budget value associated with the account identifier;
determining, in real time, that the event cost value exceeds the remaining budget value;
generating, in real time, an adjusted event cost value to correspond to the remaining budget value based on the determining that the event cost value exceeds the remaining budget value; and
generating, in real time, a real-time billing report including the adjusted event cost value.
